(19) United States
(12) Patent Application Publication
(10) Pub. No.: US 2011/0264554 A1
(43) Pub. Date: Oct. 27, 2011

(54) Personal Barcode Scanning Device and Phone Application

(76) Inventor: Christine King, Brooklyn, NY (US)

(21) Appl. No.: 13/090,342

(22) Filed: Apr. 20, 2011

Related U.S. Application Data
(60) Provisional application No. 61/326,404, filed on Apr. 21, 2010.

(51) Int. Cl. G06Q 30/00

(52) U.S. Cl. 705/26.8; 235/383

(57) ABSTRACT

A purchase monitoring device, used by a shopper having items with barcodes that identifies the item and the store price. The device includes a portable handset having a barcode scanner that enables pricing and identification data of the selected items to display on an LED or other display of the handset. The device further includes an alphanumeric keypad allowing the shopper to input budget information. The device further includes a memory means and a data transfer means allowing the store pricing and item information transfer from the internet via the user's home computer or a computer made available at the location of the store. The handset device is usable as a keychain and further includes a speaker and audio communications mode.

### CROSS REFERENCE TO RELATED APPLICATION

This application claims the benefit of U.S. Provisional Application No. 61/326,404 filed on Apr. 21, 2010, entitled “Smart Shopper.”

### BACKGROUND OF THE INVENTION

1. Field of the Invention

The present invention relates to a purchase monitoring device used to scan the price of select items and to store and list a running total of purchase items, thereby providing an effective means of enabling practitioners to be aware of article pricing and maintain a budget.

When shopping, particularly for groceries, it is difficult to estimate the final cost of all items purchased. Once the items and tax are totaled at the register, many individuals find that the final amount is outside of their budget. Shoppers must then pick through the items and return those of lower priority. This can be a very time consuming, frustrating and even a potentially embarrassing process. Individuals may be afraid of overspending, and thus intentionally skip some of the items on their list. During checkout, they realize they could have in fact purchased the items and remained within their budget, requiring a second trip through checkout or embarrassing delays with the clerk. A more efficient method for totaling purchases during the shopping process is needed.

When shopping at a self-service store such as a supermarket, consumers often encounter a number of inconveniences. One of these inconveniences includes the difficulty in determining the price of individual items. Unfortunately, prices often change because of promotions and the like, and are sometimes difficult to identify with regard to the prices displayed on the shelves. A further difficulty encountered at these stores involves the need of many customers to stick to a predetermined, precise budget, thereby necessitating that the cost of items to be purchased be calculated and known before checkout to avoid delays or embarrassment as a result of a deficiency of funds.

The present invention is a device designed to assist shoppers in identifying a price for a particular item and then tallying up the cost of all gathered items before heading to the checkout line. The device is used while shopping, enabling shoppers to stay within their shopping budget and add or remove items from the cart as needed. The present invention provides convenience by eliminating the guesswork that often accompanies grocery shopping by keeping a constant update of how much is spent, thereby assisting in maintaining a budget. The handset maintains a list of merchandise selected for purchase by the customer within internal memory means.

Recently, cell phones have begun to take advantage of this technology. Smart phone programs have now been designed to successfully read and interpret barcodes of various types. In particular, the use of Quick Response (QR) codes is becoming more common. QR codes allow associations with websites or other product information, thus a scanner such as the present invention as embodied by a cell phone and associated software application could interpret QR codes and take appropriate action, such as showing the store price for the item, tallying the price to a running total, or direct the user to specific website for product information. In this form, a cell phone application may perform the task of the present invention's preferred apparatus embodiment.

2. Description of the Prior Art

Patents have been granted to several devices that attempt to address some of these problems in relation to purchase monitoring and scanning. However, the prior art fails to provide an easy-to-use portable device that takes into account all of the foregoing issues and is adaptable for use at any store without significant cost to the user or retail merchant.

Dumont U.S. Pat. No. 5,345,071 is directed to a purchase monitoring device, to be used by a shopper in a self-service checkout store having items with bar codes which identify the item and its price, the device including primarily a portable handset having a bar code scanner, which enables pricing and identification data to be displayed on an LED on the handset. Through the selective use of a price check button, a purchase button, and a return button, the price of the item may be checked, added to a running total of purchase items, or removed from a running total of purchased items. Ruppert U.S. Pat. No. 5,424,524 is directed to a personal bar code scanning device for shoppers to track expenditures and speeding the process of checkout, as well as taking advantage of coupons. A microprocessor coupled to a bar code reader, a communication port, an audible feedback device and a touch screen or light pen and display combination carries out bar code scanning in a store as a shopper shops. The inventions described in Dumont and Ruppert require the implementation of store wide communication systems. The present invention does not require such a system and may be easily and cost-effectively implemented at any retail location with a simple personal computer.

Nelson U.S. Pat. No. 5,939,695 is directed to a device for providing product information to customers of a retail establishment. The device is a hand-held unit that contains a detector to identify a product located nearby. The identification can be accomplished through scanning a bar code affixed to the product. Once the product is identified, the device retrieves descriptive information about the product from memory, and displays the information to the customer. Tracy U.S. Pat. No. 5,979,757 is directed to an improved portable shopping system. The shopping system is provided with an improved data presentation system for presenting customer desired data on a portable terminal. The portable terminal includes audio as well as video presentation means to provide customer specific marketing and promote the sale of identified items. The inventions described in the Nelson and Tracy patents are directed primarily to marketing and other retail information rather than efficiently assisting the shopper in both product selection and budget maintenance.

Burke U.S. Pat. No. 6,604,681 is directed to an evaluative shopping assistant system and method to provide the consumer with information about a product. The system includes a hand-held device having a bar code reader or other unique means of entering a product identifier, and a display mechanism. The hand-held device is connected via wired or wireless connection to a computer that interfaces with a database of information. In use, the hand-held device reads the bar code, sends the information to a computer, and retrieves the appropriate information about the product. The computer then sends the retrieved information to the hand-held device for display.

Similar to the invention described in Burke, Harding U.S. Pat. No. 6,978,930 is directed to a shopping system for scanning codes related to products, such as consumer goods and services, and for retrieving data associated with the codes. The system includes a portable, hand-held and battery-operated optical code scanner for scanning, capturing, storing and decoding information related to scanned codes, at least a shopping kiosk having a processor, and at least a host computer operatively coupled to the shopping kiosk. The scanner and the shopping kiosk are configured such that the scanner transfers decoded data to the kiosk, and the kiosk provides the transferred decoded data in a useable format by means of a display monitor and/or a printer. Upon receipt and recognition of the transferred decoded data and/or the identification code, the first host computer selects and retrieves stored information associated with the decoded data. Such retrieved information downloads to the kiosk and is displayed to the identified user. Both the Burke and Harding inventions require significant investment on the part of the retail owner and involve installation of major wired or wireless systems.

These prior art devices have several known drawbacks, however the most significant of these is that a system is required to be installed and in place, thus making the use of any of the described devices very costly. Additionally, it is likely that such a system would be proprietary and only work in stores that had installed a particular system by the same manufacturer. The present invention works without the need of an involved wired or wireless system. The only additional requirement of the retailer would be to make their barcodes and prices available either through the Internet, and thus the users home PC, or through a PC or other device located at the front of the retail location. This should be significantly less costly than installing proprietary system, as well as allowing the practitioner to use the device in a multitude of stores. Further, such relatively simple and economical installation allows the present invention to be used in a wide variety of stores. Ideally, the present invention would be usable in establishments beyond grocery stores including any other sorts of retailers in which tracking one's budget might be useful. Specifically, this could include clothing merchants, furniture stores or any other retailer where the shopper may have budgetary concerns.

It is also noted that the prior art, because of reliance on storewide systems, tend to be larger, more complex and not removable from the particular base retail establishment. The present invention is small, lightweight, and highly portable, allowing the user to own and carry the device in their purse or pocket, preferably as a keychain. Further, the device may be adapted to an associated phone application allowing for its use on a cell phone or Smartphone device with associated software for performing the same functions as the physical device.

The present invention will greatly assist consumers and store owners alike since it is easily adapted for use by the average consumer. Currently in the art, inventions are limited to single store systems and devices that are neither plausible to carry nor implement in a large number of retail establishments

### SUMMARY OF THE INVENTION

In view of the foregoing disadvantages inherent in the known types of purchase monitoring devices now present in the prior art, the present invention provides a new portable and easy to use device wherein the same can be utilized for providing convenience for the user when shopping at any store or retail establishment willing to share their price and barcode information.

The present invention is directed to a barcode scanning and purchase monitoring device. Most stores include items having bar codes thereon, which are scanned to identify the items and prices thereof. The present invention utilizes this technology, in either a standard bar code format or QR code format. The present invention primarily includes a portable handset, which is lightweight and is a size suitable for attachment to a key chain. This exterior casing includes a front face and a rear face. Contained within the handset are data storage means that stores price and identification data corresponding individual bar codes of store items. The present invention further includes a bar code scanner, which is disposed in a scanning position on the rear face of the handset, is adapted to scan an item's bar code and correspondingly identify its information stored within the data storage means. The bar code scanner is positioned such that upon passage of the rear face of the handset over the selected item, its barcode is scanned.

Further contained within the handset are memory means. The memory means are adapted to store the particular pricing and identification of data of each of the items designated for purchase by the shopper. Further, the memory means adds all of the prices of the purchase items entered therein to provide a total purchase amount displayed on the display means, thereby providing a shopper with a constant update of how much they are spending. Alternatively, the memory means subtracts all the prices of the purchase items entered therein to provide a total budget amount remaining to display on the display means, providing a shopper with a constant update of how much of their budget remains. Positioned on a proximal rear face of the casing of the handset is a plurality of buttons, including an alphanumeric keypad. These buttons include an enter button, a delete button, and a clear button. Enter button allows for confirmation of amounts or other data entered. The delete button allows the user to delete a mistyped letter or number or remove an item. The clear button allows an action to be canceled or budget total to be cleared. The device further contains an audio button, which enables audible feedback of the current operation or amount of the budget (such as if an item is successfully scanned or the price of an item).

Disposed on the front face of the handset is an alphanumeric key pad. The alphanumeric key pad enables entry by the shopper of a budget amount corresponding to a maximum amount of money that may be spent by the shopper at the store. This budget amount is stored in the memory means and displayed on the display means, thereby enabling a user to refer to the budget amount in determining how much more to purchase. The handset, which includes its own independent power source, includes a Universal Serial Bus (USB) or other transmission port on the side of the casing. This port is particularly adapted to enable updated pricing and identification data to transmit from the user's PC or a store computer to the data storage means within the handset.

The device described by the present invention may be alternatively implemented as a cell phone software application. As an application, the present invention could remotely access internet servers containing a store's pricing and barcode information. The application could be directed to a specific internet location to gather pricing date provided by a store, and designated on the store item's barcode or QR code. This embodiment features all of the functions of the physical apparatus within a software structure that allows for the same features and utility of the disclosed invention, without requiring a physical apparatus to accomplish the same tasks. In this way, the application adds to the modularity of the disclosed invention, requiring only a smart phone to scan, track and tally a list of items with regard to a budget.

It is therefore an object of the present invention to provide a purchase monitoring device capable of assisting the practitioner with monitoring and maintaining a set budget while shopping. Another object of the present invention is to provide a device capable of totaling up to or subtracting from a preset budget during shopping. Yet another object of the present invention is to provide a cell phone application capable of purchase monitoring and assisting in maintaining a set budget while shopping.

Other objects, features and advantages of the present invention will become apparent from the following detailed description taken in conjunction with the accompanying drawings.

### BRIEF DESCRIPTIONS OF THE DRAWINGS

FIG. 1 is a perspective view of the front face of the present invention used as a keychain.

FIG. 2 is a perspective view of the rear face of the present invention, exemplifying the barcode scanner.

### DETAILED DESCRIPTION OF THE INVENTION

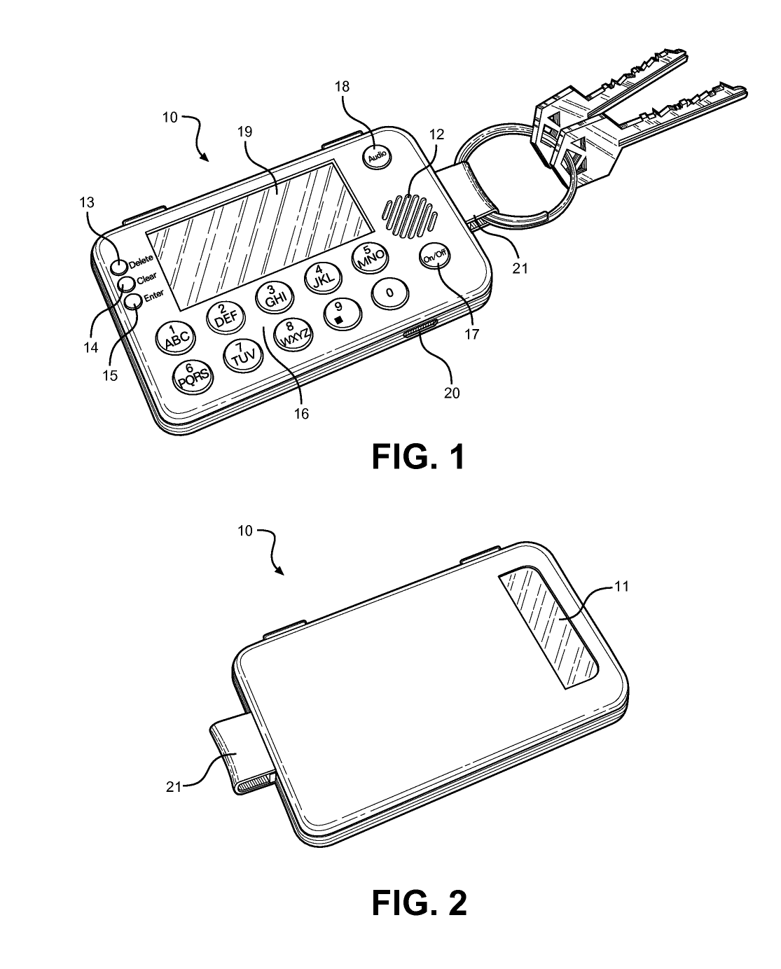

Referring now to FIG. 1, there is shown a perspective view of the front side of the present invention. The handset 10 has overall dimensions and construction to permit the scanner attachment to a key ring via the curing attachment loop 21. The handset 10 is further configured and sized to contain data in memory storage, as well as a barcode scanner 11 and speaker 12. The front side of the handset contains a delete button 13, a clear button 14 and an enter button 15, as well as an alphanumeric keypad or other keys allowing the input of both letters and numbers 16. Further, the front side of the invention contains an on/off button or switch 17 to turn the power of the device on or off. The front side of the device additionally contains an audio button 18 and speaker 12 allowing for audio feedback. The front side of the device further contains an LED or other digital display 19 on which product pricing and other budgetary data may be displayed. A USB 20 or other data port is located on the side of the device allowing for easy connection to either the stores computer or the practitioner's home PC.

Referring now to FIG. 2, there is shown a perspective view of the rear side of the present invention. The rear side of the handset contains a barcode scanner 11. Additionally, the key chain loop 21 is illustrated on the side of the device. The rear side of the handset may contain additional buttons, clips or other aspects as needed to enhance the operability of the present invention.

In use, the present invention affords consumers the ability to tally up the cost of their purchases before heading to the checkout line. The invention consists of a small electronic device 10 that can be attached via a key ring loop 21 to a key ring for easy storage. The device may be made of plastic or other suitable material. The rear side of the device may contain a barcode scanner 11 used to scan the items that are to be purchased and tallied. The barcode scanner 11 is capable of reading a variety of barcodes, including but not limited to: UPC, QR, EAN and JAN codes. The front side of the device may contain a LED or other digital display 19, which displays the total price of the items scanned. Once an item is scanned, the barcode or QR code is displayed on the display 19 and the price is added or subtracted from the budgeted amount as desired. The barcode scanner 11 may scan manufacturers or store coupons to change prices from those of the store data. A small speaker 12 may be included so that the name and price of each item may be audibly announced. The device is also capable of tracking a predetermined budget by counting up or counting down to the budget goal. The side of the device contains a USB 20 or other data port capable of interfacing with a computer provided by the retail store or the practitioner's home PC to download store barcode and pricing information to the data storage means within the device.

This device may also be converted into a cellular phone application for added convenience. The cellular phone application embodiment of the present invention may be directed using a QR code, or other means, to a store website or internet database to download barcode and pricing information via the Internet. The same functions presented in the apparatus of the present invention are enabled in the application software, allowing tracking of each item, adding or subtracting from a predetermined budget, audible responses and keypad entry of data. This embodiment provides the user with the ability to perform the functions of the present invention without carrying both a smart phone device and the keychain electronic device.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. To be used by the shopper, a purchase monitoring device comprising:
a portable handset,
said handset comprising an exterior casing having a front face and a rear face,
data storage means within said handset structured and disposed to store pricing and identification data corresponding to individual bar codes,
a bar code scanner on said handset rear face structured and disposed to selectively designate a price for an item,
display means on said handset front face disposed to display pricing, product and identification information thereon,
memory means structured to store pricing and identification data of said items selected by the shopper,
said memory means being further disposed to store the total budget amount as entered by the practitioner,
a plurality of buttons on the front face of said handset structure,
said plurality of buttons further including an alphanumeric or other keypad allowing the entry of numbers and letters, including, specifically a budget amount,
said memory means being further disposed to add the price of all said selected items so as to provide a running total purchase amount to be displayed on said display means,
said memory means being further disposed to subtract the price of all said selected items from said budget amount so as to provide a remaining budget amount to be displayed on said display means,
said memory means being further disposed to subtract said running total from said budget amount
a power source within the handset,
and a USB or other communications port allowing an interface with a personal computer or store kiosk.

2. A purchase monitoring device as recited in claim 1, wherein said handset further includes at least one enter or confirmation button disposed on said front face of said handset, said enter or confirmation button being structured and disposed to be pushed and accordingly indicate that a number being entered on said keypad is said budget amount.

3. A purchase monitoring device as recited in claim 1, wherein said display means includes an LED display.

4. A purchase monitoring device as recited in claim 1, wherein said handset includes a battery low warning signal structured and disposed to indicate when said power source is low in charge.

5. A purchase monitoring device as recited in claim 1, wherein said USB or other communications device allows the retrieval of store pricing and product information via a store computer or the practitioner's home PC.

6. A cell phone application comprising;
a module to connect to and download store pricing and product information via the internet,
a module to read bar codes and retrieve the downloaded pricing and product information,
a module to allow the input of a total budget,
a module to allow the addition of purchases items to indicate a running total or the subtraction of items from the budget to indicate the amount remaining.
